(19) United States
(12) Patent Application Publication
(10) Pub. No.: US 2026/0246948 A1
(43) Pub. Date: Aug. 20, 2026

(54) METHOD, APPARATUS, AND MEDIUM FOR POINT CLOUD CODING

(71) Applicants: Douyin Vision Co, Ltd., Beijing (CN); Bytedance Inc., Los Angeles, CA (US)

(72) Inventors: Yingzhan XU, Beijing (CN); Wenyi WANG, Beijing (CN); Bharath VISHWANATH, Los Angeles, CA (US); Kai ZHANG, Los Angeles, CA (US); Li ZHANG, Los Angeles, CA (US)

(21) Appl. No.: 19/641,189

(22) Filed: Apr. 7, 2026

Related U.S. Application Data
(63) Continuation of application No. PCT/CN2024/123290, filed on Oct. 7, 2024.

(30) Foreign Application Priority Data
Oct. 7, 2023 (WO) PCT/CN2023/123266

(51) Int. Cl. H04N 19/159; H04N 19/105; H04N 19/172

(52) U.S. Cl. CPC H04N 19/159; H04N 19/105; H04N 19/172

(57) ABSTRACT

Embodiments of this disclosure provide a solution for point cloud coding. A method for point cloud coding is proposed. In the method, for a conversion between a current frame of a point cloud sequence and a bitstream of the point cloud sequence, a prediction mode for a region of the current frame is determined. The prediction mode at least comprises a first mode based on an intra prediction and an inter prediction. A prediction of the region is determined based on the prediction mode. The conversion is performed based on the prediction.

### CROSS-REFERENCE

This application is a continuation of International Application No. PCT/CN2024/123290, filed on Oct. 7, 2024, which claims the benefit of International Application No. PCT/CN2023/123266 filed on Oct. 7, 2023. The entire contents of these applications are hereby incorporated by reference in their entireties.

### FIELD

Embodiments of the present disclosure relates generally to video coding techniques, and more particularly, to prediction mode determination.

### BACKGROUND

A point cloud is a collection of individual data points in a three-dimensional (3D) plane with each point having a set coordinate on the X, Y, and Z axes. Thus, a point cloud may be used to represent the physical content of the three-dimensional space. Point clouds have shown to be a promising way to represent 3D visual data for a wide range of immersive applications, from augmented reality to autonomous cars.

Point cloud coding standards have evolved primarily through the development of the well-known MPEG organization. MPEG, short for Moving Picture Experts Group, is one of the main standardization groups dealing with multimedia. In 2017, the MPEG 3D Graphics Coding group (3DG) published a call for proposals (CFP) document to start to develop point cloud coding standard. The final standard will consist in two classes of solutions. Video-based Point Cloud Compression (V-PCC or VPCC) is appropriate for point sets with a relatively uniform distribution of points. Geometry-based Point Cloud Compression (G-PCC or GPCC) is appropriate for more sparse distributions. However, coding efficiency of conventional point cloud coding techniques is generally expected to be further improved.

### SUMMARY

Embodiments of the present disclosure provide a solution for point cloud coding.

In a first aspect, a method for point cloud coding is proposed. The method comprises: determining, for a conversion between a current frame of a point cloud sequence and a bitstream of the point cloud sequence, a prediction mode for a region of the current frame, the prediction mode at least comprising a first mode based on an intra prediction and an inter prediction; determining a prediction of the region based on the prediction mode; and performing the conversion based on the prediction.

In a second aspect, another method for point cloud coding is proposed. The method comprises: determining, for a conversion between a current frame of a point cloud sequence and a bitstream of the point cloud sequence, that a region-adaptive hierarchical transform (RAHT) attribute coding is enabled for the current frame; and performing the conversion based on the RAHT attribute coding, wherein if the RAHT attribute coding is enabled for the point cloud sequence, at least one parameter for at least one quantization matrix for RAHT coefficients is indicated in the bitstream, and wherein if the RAHT attribute coding is disabled for the point cloud sequence, the at least one parameter for the at least one quantization matrix for RAHT coefficients is excluded from the bitstream.

In a third aspect, an apparatus for processing point cloud sequence is proposed. The apparatus for processing point cloud sequence comprises a processor and a non-transitory memory with instructions thereon. The instructions upon execution by the processor, cause the processor to perform a method in accordance with the first or second aspect of the present disclosure.

In a fourth aspect, a non-transitory computer-readable storage medium is proposed. The non-transitory computer-readable storage medium stores instructions that cause a processor to perform a method in accordance with the first or second aspect of the present disclosure.

In a fifth aspect, a non-transitory computer-readable recording medium is proposed. The non-transitory computer-readable recording medium stores a bitstream of a point cloud sequence which is generated by a method performed by a point cloud processing apparatus. The method comprises: determining a prediction mode for a region of a current frame of the point cloud sequence, the prediction mode at least comprising a first mode based on an intra prediction and an inter prediction; determining a prediction of the region based on the prediction mode; and generating the bitstream based on the prediction.

In a sixth aspect, a method for storing a bitstream of a point cloud sequence is proposed. The method comprises: determining a prediction mode for a region of a current frame of the point cloud sequence, the prediction mode at least comprising a first mode based on an intra prediction and an inter prediction; determining a prediction of the region based on the prediction mode; generating the bitstream based on the prediction; and storing the bitstream in a non-transitory computer-readable recording medium.

In a seventh aspect, another non-transitory computer-readable recording medium is proposed. The non-transitory computer-readable recording medium stores a bitstream of a point cloud sequence which is generated by a method performed by a point cloud processing apparatus. The method comprises: determining that a region-adaptive hierarchical transform (RAHT) attribute coding is enabled for a current frame of the point cloud sequence; and generating the bitstream based on the RAHT attribute coding, wherein if the RAHT attribute coding is enabled for the point cloud sequence, at least one parameter for at least one quantization matrix for RAHT coefficients is indicated in the bitstream, and wherein if the RAHT attribute coding is disabled for the point cloud sequence, the at least one parameter for the at least one quantization matrix for RAHT coefficients is excluded from the bitstream.

In an eighth aspect, another method for storing a bitstream of a point cloud sequence is proposed. The method comprises: determining that a region-adaptive hierarchical transform (RAHT) attribute coding is enabled for a current frame of the point cloud sequence; generating the bitstream based on the RAHT attribute coding; and storing the bitstream in a non-transitory computer-readable recording medium, wherein if the RAHT attribute coding is enabled for the point cloud sequence, at least one parameter for at least one quantization matrix for RAHT coefficients is indicated in the bitstream, and wherein if the RAHT attribute coding is disabled for the point cloud sequence, the at least one parameter for the at least one quantization matrix for RAHT coefficients is excluded from the bitstream.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example point cloud coding system, in accordance with some embodiments of the present disclosure;

FIG. 2 illustrates a block diagram that illustrates an example of a GPCC encoder, in accordance with some embodiments of the present disclosure;

FIG. 3 illustrates a block diagram that illustrates an example of a GPCC decoder, in accordance with some embodiments of the present disclosure;

FIG. 4 illustrates parent-level nodes for each sub-node of transform unit node;

FIG. 5 illustrates an example flowchart of the improved attribute prediction when there are two reference frames in accordance with some embodiments of the present disclosure;

FIG. 6 illustrates a flowchart of a method for point cloud coding in accordance with some embodiments of the present disclosure;

FIG. 7 illustrates a flowchart of another method for point cloud coding in accordance with some embodiments of the present disclosure; and

FIG. 8 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

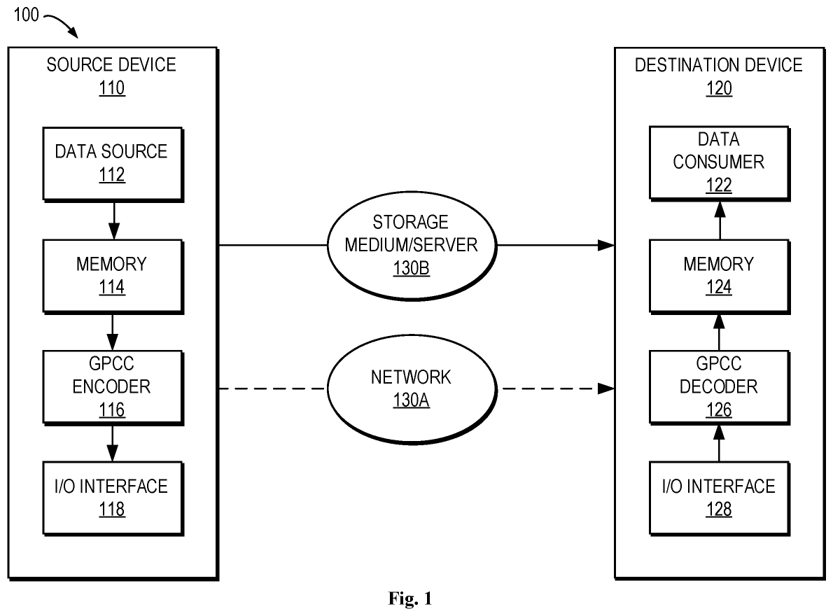

FIG. 1 is a block diagram that illustrates an example point cloud coding system 100 that may utilize the techniques of the present disclosure. As shown, the point cloud coding system 100 may include a source device 110 and a destination device 120. The source device 110 can be also referred to as a point cloud encoding device, and the destination device 120 can be also referred to as a point cloud decoding device. In operation, the source device 110 can be configured to generate encoded point cloud data and the destination device 120 can be configured to decode the encoded point cloud data generated by the source device 110. The techniques of this disclosure are generally directed to coding (encoding and/or decoding) point cloud data, i.e., to support point cloud compression. The coding may be effective in compressing and/or decompressing point cloud data.

Source device 100 and destination device 120 may comprise any of a wide range of devices, including desktop computers, notebook (i.e., laptop) computers, tablet computers, set-top boxes, telephone handsets such as smartphones and mobile phones, televisions, cameras, display devices, digital media players, video gaming consoles, video streaming devices, vehicles (e.g., terrestrial or marine vehicles, spacecraft, aircraft, etc.), robots, LIDAR devices, satellites, extended reality devices, or the like. In some cases, source device 100 and destination device 120 may be equipped for wireless communication.

The source device 100 may include a data source 112, a memory 114, a GPCC encoder 116, and an input/output (I/O) interface 118. The destination device 120 may include an input/output (I/O) interface 128, a GPCC decoder 126, a memory 124, and a data consumer 122. In accordance with this disclosure, GPCC encoder 116 of source device 100 and GPCC decoder 126 of destination device 120 may be configured to apply the techniques of this disclosure related to point cloud coding. Thus, source device 100 represents an example of an encoding device, while destination device 120 represents an example of a decoding device. In other examples, source device 100 and destination device 120 may include other components or arrangements. For example, source device 100 may receive data (e.g., point cloud data) from an internal or external source. Likewise, destination device 120 may interface with an external data consumer, rather than include a data consumer in the same device.

In general, data source 112 represents a source of point cloud data (i.e., raw, unencoded point cloud data) and may provide a sequential series of “frames” of the point cloud data to GPCC encoder 116, which encodes point cloud data for the frames. In some examples, data source 112 generates the point cloud data. Data source 112 of source device 100 may include a point cloud capture device, such as any of a variety of cameras or sensors, e.g., one or more video cameras, an archive containing previously captured point cloud data, a 3D scanner or a light detection and ranging (LIDAR) device, and/or a data feed interface to receive point cloud data from a data content provider. Thus, in some examples, data source 112 may generate the point cloud data based on signals from a LIDAR apparatus. Alternatively or additionally, point cloud data may be computer-generated from scanner, camera, sensor or other data. For example, data source 112 may generate the point cloud data, or produce a combination of live point cloud data, archived point cloud data, and computer-generated point cloud data. In each case, GPCC encoder 116 encodes the captured, pre-captured, or computer-generated point cloud data. GPCC encoder 116 may rearrange frames of the point cloud data from the received order (sometimes referred to as “display order”) into a coding order for coding. GPCC encoder 116 may generate one or more bitstreams including encoded point cloud data. Source device 100 may then output the encoded point cloud data via I/O interface 118 for reception and/or retrieval by, e.g., I/O interface 128 of destination device 120. The encoded point cloud data may be transmitted directly to destination device 120 via the I/O interface 118 through the network 130A. The encoded point cloud data may also be stored onto a storage medium/server 130B for access by destination device 120.

Memory 114 of source device 100 and memory 124 of destination device 120 may represent general purpose memories. In some examples, memory 114 and memory 124 may store raw point cloud data, e.g., raw point cloud data from data source 112 and raw, decoded point cloud data from GPCC decoder 126. Additionally or alternatively, memory 114 and memory 124 may store software instructions executable by, e.g., GPCC encoder 116 and GPCC decoder 126, respectively. Although memory 114 and memory 124 are shown separately from GPCC encoder 116 and GPCC decoder 126 in this example, it should be understood that GPCC encoder 116 and GPCC decoder 126 may also include internal memories for functionally similar or equivalent purposes. Furthermore, memory 114 and memory 124 may store encoded point cloud data, e.g., output from GPCC encoder 116 and input to GPCC decoder 126. In some examples, portions of memory 114 and memory 124 may be allocated as one or more buffers, e.g., to store raw, decoded, and/or encoded point cloud data. For instance, memory 114 and memory 124 may store point cloud data.

I/O interface 118 and I/O interface 128 may represent wireless transmitters/receivers, modems, wired networking components (e.g., Ethernet cards), wireless communication components that operate according to any of a variety of IEEE 802.11 standards, or other physical components. In examples where I/O interface 118 and I/O interface 128 comprise wireless components, I/O interface 118 and I/O interface 128 may be configured to transfer data, such as encoded point cloud data, according to a cellular communication standard, such as 4G, 4G-LTE (Long-Term Evolution), LTE Advanced, 5G, or the like. In some examples where I/O interface 118 comprises a wireless transmitter, I/O interface 118 and I/O interface 128 may be configured to transfer data, such as encoded point cloud data, according to other wireless standards, such as an IEEE 802.11 specification. In some examples, source device 100 and/or destination device 120 may include respective system-on-a-chip (SoC) devices. For example, source device 100 may include an SoC device to perform the functionality attributed to GPCC encoder 116 and/or I/O interface 118, and destination device 120 may include an SoC device to perform the functionality attributed to GPCC decoder 126 and/or I/O interface 128.

The techniques of this disclosure may be applied to encoding and decoding in support of any of a variety of applications, such as communication between autonomous vehicles, communication between scanners, cameras, sensors and processing devices such as local or remote servers, geographic mapping, or other applications.

I/O interface 128 of destination device 120 receives an encoded bitstream from source device 110. The encoded bitstream may include signaling information defined by GPCC encoder 116, which is also used by GPCC decoder 126, such as syntax elements having values that represent a point cloud. Data consumer 122 uses the decoded data. For example, data consumer 122 may use the decoded point cloud data to determine the locations of physical objects. In some examples, data consumer 122 may comprise a display to present imagery based on the point cloud data.

GPCC encoder 116 and GPCC decoder 126 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of GPCC encoder 116 and GPCC decoder 126 may be included in one or more encoders or decoders, either of which may be integrated as part of a combined encoder/decoder (CODEC) in a respective device. A device including GPCC encoder 116 and/or GPCC decoder 126 may comprise one or more integrated circuits, microprocessors, and/or other types of devices.

GPCC encoder 116 and GPCC decoder 126 may operate according to a coding standard, such as video point cloud compression (VPCC) standard or a geometry point cloud compression (GPCC) standard. This disclosure may generally refer to coding (e.g., encoding and decoding) of frames to include the process of encoding or decoding data. An encoded bitstream generally includes a series of values for syntax elements representative of coding decisions (e.g., coding modes).

A point cloud may contain a set of points in a 3D space, and may have attributes associated with the point. The attributes may be color information such as R, G, B or Y, Cb, Cr, or reflectance information, or other attributes. Point clouds may be captured by a variety of cameras or sensors such as LIDAR sensors and 3D scanners and may also be computer-generated. Point cloud data are used in a variety of applications including, but not limited to, construction (modeling), graphics (3D models for visualizing and animation), and the automotive industry (LIDAR sensors used to help in navigation).

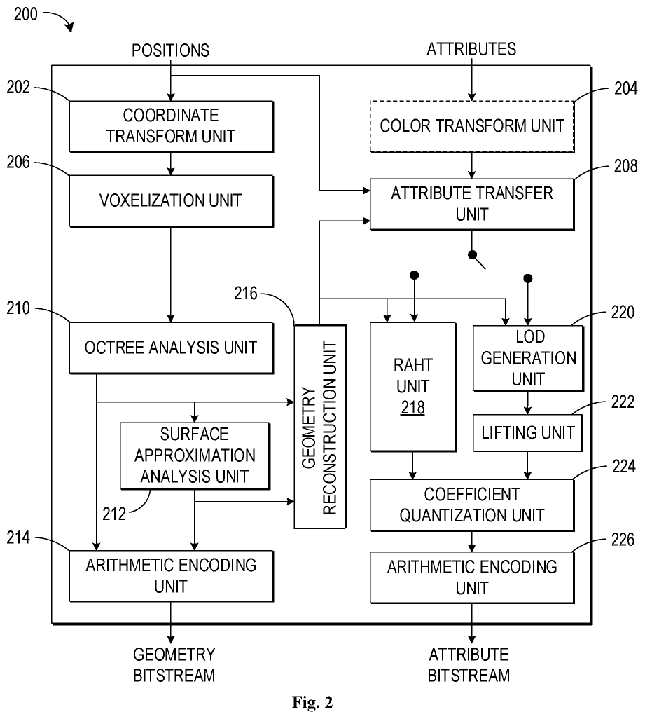

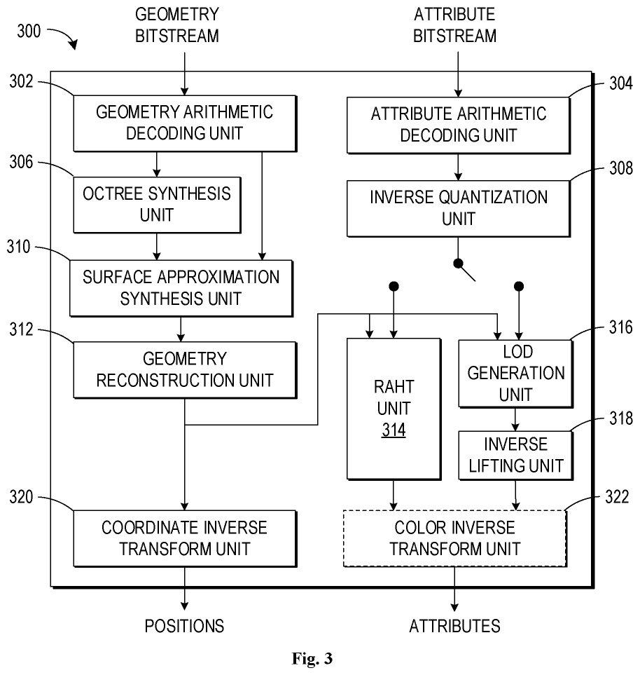

FIG. 2 is a block diagram illustrating an example of a GPCC encoder 200, which may be an example of the GPCC encoder 116 in the system 100 illustrated in FIG. 1, in accordance with some embodiments of the present disclosure. FIG. 3 is a block diagram illustrating an example of a GPCC decoder 300, which may be an example of the GPCC decoder 126 in the system 100 illustrated in FIG. 1, in accordance with some embodiments of the present disclosure.

In both GPCC encoder 200 and GPCC decoder 300, point cloud positions are coded first. Attribute coding depends on the decoded geometry. In FIG. 2 and FIG. 3, the region adaptive hierarchical transform (RAHT) unit 218, surface approximation analysis unit 212, RAHT unit 314 and surface approximation synthesis unit 310 are options typically used for Category 1 data. The level-of-detail (LOD) generation unit 220, lifting unit 222, LOD generation unit 316 and inverse lifting unit 318 are options typically used for Category 3 data. All the other units are common between Categories 1 and 3.

For Category 3 data, the compressed geometry is typically represented as an octree from the root all the way down to a leaf level of individual voxels. For Category 1 data, the compressed geometry is typically represented by a pruned octree (i.e., an octree from the root down to a leaf level of blocks larger than voxels) plus a model that approximates the surface within each leaf of the pruned octree. In this way, both Category 1 and 3 data share the octree coding mechanism, while Category 1 data may in addition approximate the voxels within each leaf with a surface model. The surface model used is a triangulation comprising 1-10 triangles per block, resulting in a triangle soup. The Category 1 geometry codec is therefore known as the Trisoup geometry codec, while the Category 3 geometry codec is known as the Octree geometry codec.

In the example of FIG. 2, GPCC encoder 200 may include a coordinate transform unit 202, a color transform unit 204, a voxelization unit 206, an attribute transfer unit 208, an octree analysis unit 210, a surface approximation analysis unit 212, an arithmetic encoding unit 214, a geometry reconstruction unit 216, an RAHT unit 218, a LOD generation unit 220, a lifting unit 222, a coefficient quantization unit 224, and an arithmetic encoding unit 226.

As shown in the example of FIG. 2, GPCC encoder 200 may receive a set of positions and a set of attributes. The positions may include coordinates of points in a point cloud. The attributes may include information about points in the point cloud, such as colors associated with points in the point cloud.

Coordinate transform unit 202 may apply a transform to the coordinates of the points to transform the coordinates from an initial domain to a transform domain. This disclosure may refer to the transformed coordinates as transform coordinates. Color transform unit 204 may apply a transform to convert color information of the attributes to a different domain. For example, color transform unit 204 may convert color information from an RGB color space to a YCbCr color space.

Furthermore, in the example of FIG. 2, voxelization unit 206 may voxelize the transform coordinates. Voxelization of the transform coordinates may include quantizing and removing some points of the point cloud. In other words, multiple points of the point cloud may be subsumed within a single “voxel,” which may thereafter be treated in some respects as one point. Furthermore, octree analysis unit 210 may generate an octree based on the voxelized transform coordinates. Additionally, in the example of FIG. 2, surface approximation analysis unit 212 may analyze the points to potentially determine a surface representation of sets of the points. Arithmetic encoding unit 214 may perform arithmetic encoding on syntax elements representing the information of the octree and/or surfaces determined by surface approximation analysis unit 212. GPCC encoder 200 may output these syntax elements in a geometry bitstream.

Geometry reconstruction unit 216 may reconstruct transform coordinates of points in the point cloud based on the octree, data indicating the surfaces determined by surface approximation analysis unit 212, and/or other information. The number of transform coordinates reconstructed by geometry reconstruction unit 216 may be different from the original number of points of the point cloud because of voxelization and surface approximation. This disclosure may refer to the resulting points as reconstructed points. Attribute transfer unit 208 may transfer attributes of the original points of the point cloud to reconstructed points of the point cloud data.

Furthermore, RAHT unit 218 may apply RAHT coding to the attributes of the reconstructed points. Alternatively or additionally, LOD generation unit 220 and lifting unit 222 may apply LOD processing and lifting, respectively, to the attributes of the reconstructed points. RAHT unit 218 and lifting unit 222 may generate coefficients based on the attributes. Coefficient quantization unit 224 may quantize the coefficients generated by RAHT unit 218 or lifting unit 222. Arithmetic encoding unit 226 may apply arithmetic coding to syntax elements representing the quantized coefficients. GPCC encoder 200 may output these syntax elements in an attribute bitstream.

In the example of FIG. 3, GPCC decoder 300 may include a geometry arithmetic decoding unit 302, an attribute arithmetic decoding unit 304, an octree synthesis unit 306, an inverse quantization unit 308, a surface approximation synthesis unit 310, a geometry reconstruction unit 312, a RAHT unit 314, a LOD generation unit 316, an inverse lifting unit 318, a coordinate inverse transform unit 320, and a color inverse transform unit 322.

GPCC decoder 300 may obtain a geometry bitstream and an attribute bitstream. Geometry arithmetic decoding unit 302 of decoder 300 may apply arithmetic decoding (e.g., CABAC or other type of arithmetic decoding) to syntax elements in the geometry bitstream. Similarly, attribute arithmetic decoding unit 304 may apply arithmetic decoding to syntax elements in attribute bitstream.

Octree synthesis unit 306 may synthesize an octree based on syntax elements parsed from geometry bitstream. In instances where surface approximation is used in geometry bitstream, surface approximation synthesis unit 310 may determine a surface model based on syntax elements parsed from geometry bitstream and based on the octree.

Furthermore, geometry reconstruction unit 312 may perform a reconstruction to determine coordinates of points in a point cloud. Coordinate inverse transform unit 320 may apply an inverse transform to the reconstructed coordinates to convert the reconstructed coordinates (positions) of the points in the point cloud from a transform domain back into an initial domain.

Additionally, in the example of FIG. 3, inverse quantization unit 308 may inverse quantize attribute values. The attribute values may be based on syntax elements obtained from attribute bitstream (e.g., including syntax elements decoded by attribute arithmetic decoding unit 304).

Depending on how the attribute values are encoded, RAHT unit 314 may perform RAHT coding to determine, based on the inverse quantized attribute values, color values for points of the point cloud. Alternatively, LOD generation unit 316 and inverse lifting unit 318 may determine color values for points of the point cloud using a level of detail-based technique.

Furthermore, in the example of FIG. 3, color inverse transform unit 322 may apply an inverse color transform to the color values. The inverse color transform may be an inverse of a color transform applied by color transform unit 204 of encoder 200. For example, color transform unit 204 may transform color information from an RGB color space to a YCbCr color space. Accordingly, color inverse transform unit 322 may transform color information from the YCbCr color space to the RGB color space.

The various units of FIG. 2 and FIG. 3 are illustrated to assist with understanding the operations performed by encoder 200 and decoder 300. The units may be implemented as fixed-function circuits, programmable circuits, or a combination thereof. Fixed-function circuits refer to circuits that provide particular functionality and are preset on the operations that can be performed. Programmable circuits refer to circuits that can be programmed to perform various tasks and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to GPCC or other specific point cloud codecs, the disclosed techniques are applicable to other point cloud coding technologies also. Furthermore, while some embodiments describe point cloud coding steps in detail, it will be understood that corresponding steps decoding that undo the coding will be implemented by a decoder.

### 1. Brief Summary

This disclosure is related to point cloud coding technologies. Specifically, it is related to point cloud attribute inter prediction in region-adaptive hierarchical transform. The ideas may be applied individually or in various combination, to any point cloud coding standard or non-standard point cloud codec, e.g., the being-developed Geometry based Point Cloud Compression (G-PCC).

### 2. Abbreviations

G-PCC Geometry based Point Cloud Compression
MPEG Moving Picture Experts Group
3DG 3D Graphics Coding Group
CFP Call For Proposal
V-PCC Video-based Point Cloud Compression
RAHT Region-Adaptive Hierarchical Transform.

### 3. Introduction

MPEG, short for Moving Picture Experts Group, is one of the main standardization groups dealing with multimedia. In 2017, the MPEG 3D Graphics Coding group (3DG) published a call for proposals (CFP) document to start to develop point cloud coding standard. The final standard will consist in two classes of solutions. Video-based Point Cloud Compression (V-PCC) is appropriate for point sets with a relatively uniform distribution of points. Geometry-based Point Cloud Compression (G-PCC) is appropriate for more sparse distributions. Both V-PCC and G-PCC support the coding and decoding for single point cloud and point cloud sequence.

In one point cloud, there may be geometry information and attribute information. Geometry information is used to describe the geometry locations of the data points. Attribute information is used to record some details of the data points, such as textures, normal vectors, reflections and so on.

### 3.1 Region-Adaptive Hierarchical Transform

In G-PCC, one of important point cloud attribute coding tools is RAHT. It is a transform that uses the attributes associated with a node in a lower level of the octree to predict the attributes of the nodes in the next level. It assumes that the positions of the points are given at both the encoder and decoder. RAHT follows the octree scan backwards, from leaf nodes to root node, at each step recombining nodes into larger ones until reaching the root node. At each level of octree, the nodes are processed in the Morton order. At each decomposition, instead of grouping eight nodes at a time, RAHT does it in three steps along each dimension, (e.g., along z, then y then x). If there are L levels in octree, RAHT takes 3L levels to traverse the tree backwards.

Let the nodes at level l be g_{l,x,y,z}, for x,y,z integers. g_{l,x,y,z} was obtained by grouping g_{l+1,2x,y,z} and g_{l+1,2x+1,y,z}, where the grouping along the first dimension was an example. RAHT only process occupied nodes. If one of the nodes in the pair is unoccupied, the other one is promoted to the next level, unprocessed, i.e., g_{l-1,x,y,z}=g_{l,2x,y,z} if the latter is the occupied node of the pair. The grouping process is repeated until getting to the root. Note that the grouping process generates nodes at lower levels that are the result of grouping different numbers of voxels along the way. The number of nodes grouped to generate node g_{l,x,y,z} is the weight ω_{l,x,y,z} of that node.

At every grouping of two nodes, say g_{l,2x,y,z} and g_{l,2x+1,y,z}, with their respective weights, ω_{l,2x,y,z} and ω_{l,2x+1,y,z}, RAHT apply the following transform:

$$[ \begin{matrix}{g}_{l - 1 , x , y , z} \\ {h}_{l - 1 , x , y , z}\end{matrix} ] = {T}_{{ω}_{1} {ω}_{2}} [ \begin{matrix}{g}_{l , 2 x , y , z} \\ {h}_{l , 2 x + 1 , y , z}\end{matrix} ] ,$$

Where ω₁=ω_{l,2x,y,z} and ω₂=ω_{l,2x+1,y,z} and

$${T}_{{ω}_{1} {ω}_{2}} = \frac{1}{\sqrt{{ω}_{1} + {ω}_{2}}} [ \begin{matrix}\sqrt{{ω}_{1}} & \sqrt{{ω}_{2}} \\ - \sqrt{{ω}_{2}} & \sqrt{{ω}_{1}}\end{matrix} ] .$$

Note that the transform matrix changes at all times, adapting to the weights, i.e., adapting to the number of leaf nodes that each g_{l,x,y,z} actually represents. The quantities g_{l,x,y,z} are used to group and compose further nodes at a lower level. h_{l,x,y,z} are the actual high-pass coefficients generated by the transform to be encoded and transmitted. Furthermore, weights accumulate for the level above. In the above example,

$${ω}_{l - 1 , 2 y , z} = {ω}_{l , 2 x , y , z} + {ω}_{l , 2 x + 1 , y , z} .$$

In the last stage, the tree root, the remaining two voxels g_{1,0,0,0} and g_{1,1,0,0} are transformed into the final two coefficients as:

$$[ \begin{matrix}{g}_{D C} \\ {h}_{0 , 0 , 0 , 0}\end{matrix} ] = {T}_{{ω}_{1 , 0 , 0 , 0} {ω}_{1 , 1 , 0 , 0}} [ \begin{matrix}{g}_{1 , 0 , 0 , 0} \\ {g}_{1 , 1 , 0 , 0}\end{matrix} ] .$$

Where g_{DC}=g_{0,0,0,0}.

### 3.3 Upsampled Transform Domain Prediction in RAHT

The transform domain prediction is introduced to improve coding efficiency on RAHT. It is formed of two parts. Firstly, the RAHT tree traversal is changed to be descent based from the previous ascent approach, i.e., a tree of attribute and weight sums is constructed and then RAHT is performed from the root of the tree to the leaves for both the encoder and the decoder. The transform is also performed in octree node transform unit that has 2×2×2 sub-nodes. Within the node, the encoder transform order is from leaves to the root.

Secondly, for each sub-node of transform unit, a corresponding predicted sub-node is produced by upsampling the previous transform level. Actually, only sub-node that contains at last one point will produce a corresponding predicted sub-node. The transform unit that contains 2×2×2 predicted sub-nodes is transformed and subtracted from the transformed attributes at the encoder side.

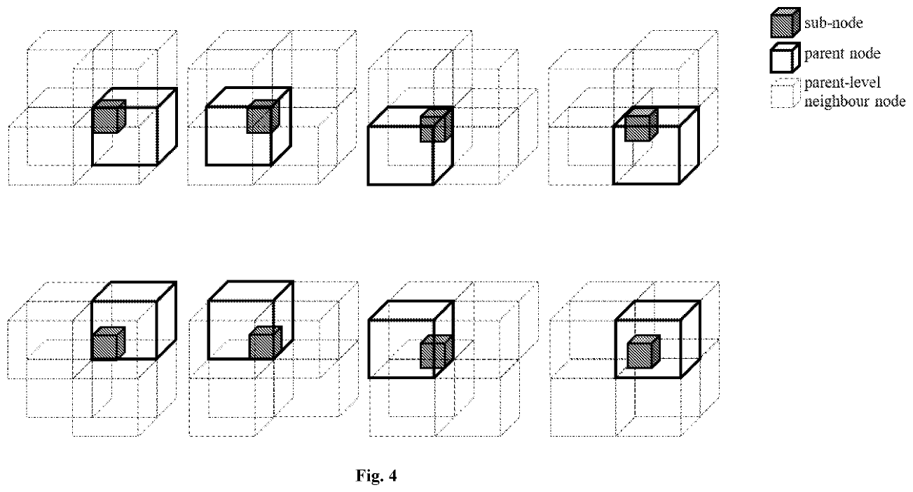

Each sub-node of transform unit node is predicted by 7 parent-level nodes where 3 coline parent-level neighbour nodes, 3 coplane parent-level neighbour nodes and 1 parent node. Coplane and coline neighbours are the neighbours that share a face and an edge with current transform unit node, respectively. FIG. 4 shows 7 parent-level nodes for each sub-node of transform unit node.

The attribute aᵤₚ of each sub-node is predicted depending on the distance between it and its parent-level node as follows.

$${a}_{u p} = \sum {ω}_{k} {a}_{k} / \sum {ω}_{k}$$

aₖ is the attribute of its one parent-level node and ωₖ is weight depending on the distance. In G-PCC, ωₚₐᵣₑₙₜ:ω_{coplane}:ω_{coline}=4:2:1.

For AC coefficient, the prediction residual will be signalled.

For DC coefficient, the coefficients are inherited from the previous level, which means that the DC coefficient is signalled without prediction.

### 3.4 Attribute Inter Prediction in RAHT

It is proposed to apply inter-prediction to DC and AC coefficients in RAHT.

For the layers enabling inter-prediction, the octree decomposition is performed on the two frames. The decomposition is derived based on the geometry information of each frame.

For each node in the current octree decomposition, it may be matched to one node in the reference decomposition. The Morton value of the matched node should be as same as the Morton value of the current node. For AC and DC coefficients of there nodes, the reference coefficients are generated in the same way as the current coefficients. The reference coefficients are used to predict the current coefficients.

For example, for AC coefficients, the prediction residual is signalled as:

$$A {C}_{r e s i d u a l} = A {C}_{c u r r e n t} - A {C}_{predicted} ,$$

$$A {C}_{p r e d i c t e d} = A {C}_{predicted \_ inter} ? {AC}_{predicted \_ inter} : {AC}_{predicted \_ intra} .$$

If the AC_{predicted_inter} is equal to zero, the AC_{predicted_intra} is applied as the original transform domain prediction.

There is one flag for each layer to indicate whether the inter-prediction is enabled. The flag is derived based on one rate-distortion optimization method.

### 3.5 AC Coefficients Quantization Offset

Signalling of 3D quantization matrices is proposed so that a QP offset can be applied to each AC coefficient of the transformed 2×2×2 residual. Note that the DC coefficient is inherited and thus there is no residual DC component that is signalled to the decoder.

### 4. Problems

The existing designs for point cloud attribute inter prediction in RAHT have the following problems:
1. In current design, the flag to indicate whether the inter-prediction is enabled is determined for each layer. However, this kind of layer level determination may be not optimal, considering the best choice for each node may be various.
2. In current design, the reference information only comes from one reference frame and there may be at most one reference node for each node. However, this kind of reference information may be not enough to provide efficient prediction.
3. In current design, the prediction value comes from either intra prediction or inter prediction. However, this kind of prediction value determination may be not optimal.
4. In current design, the indicators to indicate whether to signal the AC coefficients quantization matrices are signalled always. However, the AC coefficients quantization matrices are only used for RAHT coding method.

### 5. Detailed Solutions

To solve the above problems and some other problems not mentioned, methods as summarized below are disclosed. The embodiments should be considered as examples to explain the general concepts and should not be interpreted in a narrow way. Furthermore, these embodiments can be applied individually or combined in any manner.
1) It is proposed to determine and signal the prediction method for each node.
   a. In one example, the prediction method may be no prediction.
   b. In one example, the prediction method may be intra prediction.
   c. In one example, the prediction method may be inter prediction.
   d. In one example, the prediction method may be using the intra prediction and inter prediction to derive the prediction value.
      i. In one example, the prediction value may be the weighted average of inter prediction and intra prediction.
   e. In one example, the prediction method may be determined based on some eligibility conditions.
      i. In one example, the eligibility conditions may be based on the layer depth of the node.
      ii. In one example, the eligibility conditions may be based on the geometry location of the node.
      iii. In one example, the eligibility conditions may be based on the attribute information of the node.
      iv. In one example, the eligibility conditions may be based on the neighbor information of the node.
   f. In one example, the prediction method may be determined based on the rate-distortion optimization method.
      i. In one example, the rate and/or the distortion may be estimated.
      ii. Alternatively, the rate and/or the distortion may be calculated based on the reconstructed value.
   g. In one example, the above determination methods may be combined to be used to determine the prediction method.
   h. In one example, for each node, there may be one indicator to indicate which prediction method is determined to be applied on one node.
      i. In one example, the indicator may be signalled to the decoder.
         1. In one example, the indicator may be coded with fixed-length coding, unary coding, truncated unary coding, etc. al.
         2. In one example, the indicator may be coding in a predictive way.
2) It is proposed to determine and signal the prediction method for each region/level.
   a. In one example, the prediction method may be no prediction.
   b. In one example, the prediction method may be intra prediction.
   c. In one example, the prediction method may be inter prediction.
   d. In one example, the prediction method may be using the intra prediction and inter prediction to derive the prediction value.
      i. In one example, the prediction value may be the weighted average of inter prediction and intra prediction.
   e. In one example, the prediction method may be the combination of the above methods.
      i. In one example, the prediction value may be the prediction value of the method A if the prediction value of the method A is not zero; otherwise, the prediction value may be the prediction value of the method B.
   f. In one example, the prediction method may be applied to all nodes in the region/level.
   g. In one example, the prediction method may be determined based on some eligibility conditions.
      i. In one example, the eligibility conditions may be based on the layer depth of the region/level.
         1. In one example, there may be at least one indicator to indicate the permitted layer depth(s) or region(s) in the eligibility conditions.
         a. In one example, the indicator may be signalled to the decoder.
         i. In one example, the indicator may be coded with fixed-length coding, unary coding, truncated unary coding, etc. al.
         ii. In one example, the indicator may be coding in a predictive way.
      ii. In one example, the eligibility conditions may be based on the geometry location of the region/level.
      iii. In one example, the eligibility conditions may be based on the attribute information of the region/level.
      iv. In one example, the eligibility conditions may be based on the neighbor information of the nodes in the region/level.
   h. In one example, the prediction method may be determined based on the rate-distortion optimization method.
      i. In one example, the rate and/or the distortion may be estimated.
      ii. Alternatively, the rate and/or the distortion may be calculated based on the reconstructed value.
   i. In one example, the above determination methods may be combined to be used to determine the prediction method.
   j. In one example, for each region/level, there may be one indicator to indicate which prediction method is determined to be applied on the nodes in the region/level.
      i. In one example, the indicator may be signalled to the decoder.
         1. In one example, the indicator may be coded with fixed-length coding, unary coding, truncated unary coding, etc. al.
         2. In one example, the indicator may be coding in a predictive way.
3) It is proposed to signal the parameters to determine the prediction method.
   a. In one example, there may be some parameters to indicate the eligibility conditions for one prediction method.
   b. In one example, there may be some parameters to derive the eligibility conditions for one prediction method.
   c. In one example, there may be some parameters to indicate the regions/levels which need to check the eligibility conditions.
      i. In one example, for one prediction method, only some specific layers may need to check the eligibility conditions; other layers may not apply the prediction method.
      ii. Alternatively, for one prediction method, only some specific layers may need to check the eligibility conditions; other layers may apply the prediction method.
      iii. In one example, there may be some parameters to derive the specific layers.
   d. In one example, the above parameters may be signalled to the decoder.
      i. In one example, the parameters may be coded with fixed-length coding, unary coding, truncated unary coding, etc. al.
      ii. In one example, the parameters may be coding in a predictive way.
4) It is proposed to generate the prediction result based on the reference information from multiple reference frames.
   a. In one example, for each node, there may be multiple reference node from multiple reference frames.
   b. In one example, for each reference node, there may be one inter prediction value.
   c. In one example, for each reference node, there may be on indicator to indicate the reference node.
   d. In one example, for the current node, the prediction value may be derived from the intra prediction value and the multiple inter prediction value.
   e. In one example, the prediction value may be selected from predictor candidates.
      i. In one example, one predictor candidate may be the intra prediction value.
      ii. In one example, one predictor candidate may be the inter prediction value of one reference node if there is one reference node.
      iii. In one example, one predictor candidate may be the weighted average of intra prediction value and multiple inter prediction values if there are multiple reference nodes.
      iv. In one example, one predictor candidate may be the weighted average of intra prediction value and one inter prediction value.
      v. In one example, one predictor candidate may be the weighted average of multiple inter prediction values if there are multiple reference nodes.
   f. In one example, the selection may be determined based on the rate-distortion optimization method.
      i. In one example, the rate and/or the distortion may be estimated.
      ii. Alternatively, the rate and/or the distortion may be calculated based on the reconstructed value.
   g. In one example, there may be one indicator to indicate which predictor candidate is selected.
      i. In one example, the indicator may be signalled to the decoder.
         1. In one example, the indicator may be coded with fixed-length coding, unary coding, truncated unary coding, etc. al.
         2. In one example, the indicator may be coding in a predictive way.
5) It is proposed to fix/derive/signal the weight values which are used in the weighted average calculation described above.
   a. In one example, the weights may be fixed at the decoder.
      i. In one example, the weights may be various for each layer.
      ii. In one example, the weights may be various for each node.
      iii. In one example, the weights may be consistent for all nodes.
   b. In one example, the weights may be derived at the decoder.
      i. In one example, the weights may be derived for each layer.
         1. In one example, the weights may be derived based on the predictor candidate selection results of nodes in the previous layer(s).
         2. In one example, the weights may be derived based on the depth level.
      ii. In one example, the weights may be derived for each node.
         1. In one example, the weights may be derived based on the predictor candidate selection results of some previous coded nodes, such as the coded neighbor nodes or the parent node.
   c. In one example, the weights may be signalled to the decoder.
      i. In one example, the weights may be signalled to the decoder for each layer.
         1. In one example, the weights may be coded with fixed-length coding, unary coding, truncated unary coding, etc. al.
         2. In one example, the weights may be coding in a predictive way.
   d. In one example, the weights may be selected from the pre-defined weights candidates list.
      i. In one example, the weights may be selected by rate-distortion optimization/rate optimization/distortion optimization based method.
      ii. In one example, there may be at least one indicator to indicate the selection result.
         1. In one example, the indicator may be signalled to the decoder.
         a. In one example, the indicator may be coded with fixed-length coding, unary coding, truncated unary coding, etc. al.
         b. In one example, the indicator may be coding in a predictive way.
      iii. In one example, the selection may be performed for each layer.
      iv. In one example, the selection may be performed for each node.
6) It is proposed to signal whether the weighted average of intra prediction and inter prediction is used.
   a. In one example, there may be one indicator to indicate whether the weighted average of intra prediction and inter prediction can be enabled for the whole sequence.
   b. In one example, there may be one indicator to indicate whether the weighted average of intra prediction and inter prediction is used for one PC sample.
   c. In one example, there may be one indicator to indicate whether the weighted average of intra prediction and inter prediction is used for one layer/region.
   d. In one example, all or partial indicators described above may be signalled to the decoder.
      i. In one example, the indicators may be coded with fixed-length coding, unary coding, truncated unary coding, etc. al.
      ii. In one example, the indicators may be coding in a predictive way.
7) It is proposed to signal the parameters for RAHT coefficients quantization matrices when the RAHT attribute coding is enabled.
   a. In one example, the RAHT coefficients may be the AC coefficients.
   b. In one example, the RAHT coefficients may be the DC coefficients.
   c. In one example, the RAHT coefficients may be both AC coefficients and DC coefficients.
   d. In one example, there may be quantization matrices for AC coefficients.
   e. In one example, there may be quantization matrices for DC coefficients.
   f. In one example, there may be at least one indicator to indicate whether the RAHT coefficients quantization matrices are signalled.
      i. In one example, the indicator may be signalled to the decoder only when the RAHT attribute coding is enabled.
      ii. In one example, the indicator may be coded with fixed-length coding, unary coding, truncated unary coding, etc. al.
      iii. In one example, the indicator may be coding in a predictive way.
8) Whether to and/or how to apply a method disclosed above may be signaled from encoder to decoder in a bitstream/frame/tile/slice/octree/etc.
9) Whether to and/or how to apply the disclosed methods above may be dependent on coded information, such as dimensions, colour format, colour component, slice/picture type.

### 6. Embodiments

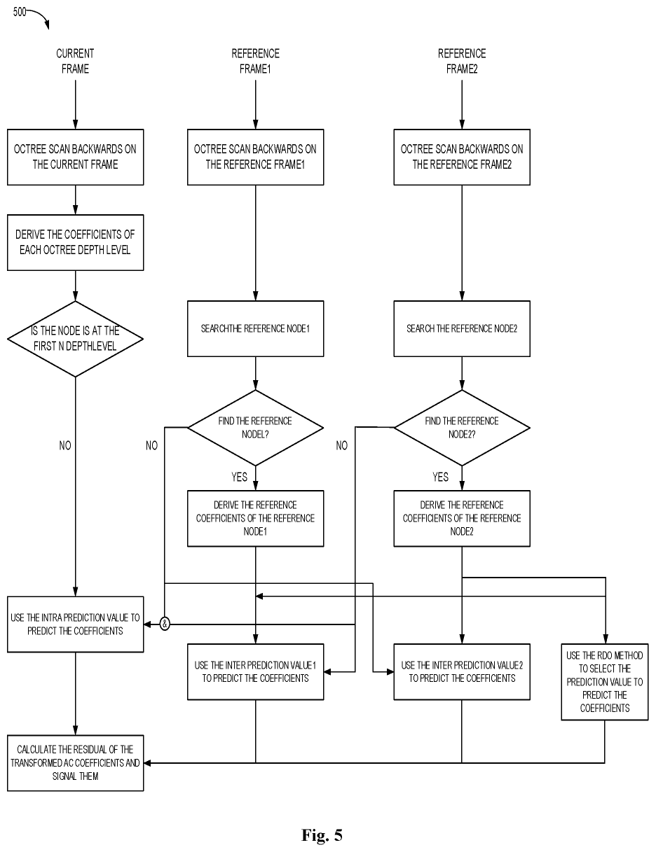

An example of the coding flow 500 for the improved inter prediction of coefficients when there are two reference frames is depicted in FIG. 5. As illustrated, a plurality of reference frames such as a reference frame 1 and a reference frame 2 may be used for coding the current frame.

Embodiments of the present disclosure are related to coding for point cloud coding. As used herein, the term “point cloud sequence” may refer to a sequence of one or more point clouds. The term “frame” may refer to a point cloud in a point cloud sequence. The term “point cloud” may refer to a frame in the point cloud sequence. The term “node” represents a spatial partition of the current frame.

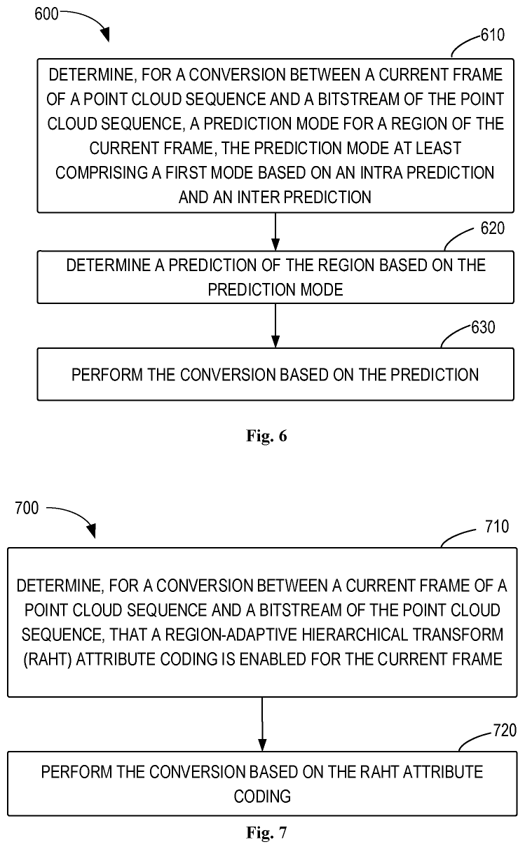

FIG. 6 illustrates a flowchart of method 600 for point cloud coding in accordance with some embodiments of the present disclosure. The method 600 may be implemented during a conversion between a current frame of a point cloud sequence and a bitstream of the point cloud sequence.

As shown in FIG. 6, the method 600 starts at block 610, where for a conversion between a current frame of a point cloud sequence and a bitstream of the point cloud sequence, a prediction mode for a region of the current frame is determined. The prediction mode at least comprises a first mode based on an intra prediction and an inter prediction. As used herein, the prediction mode may also be referred to as a prediction method or a prediction tool.

At block 620, a prediction of the region is determined based on the prediction mode.

At block 630, the conversion is performed based on the prediction. In some embodiments the conversion may include encoding the current frame into the bitstream. Alternatively, or in addition, the conversion may include decoding the current frame from the bitstream.

The method 600 enables determining a prediction mode for a region such as at least one node. The point cloud coding can thus be enhanced.

In some embodiments, in the first mode, the prediction of the region comprises a weighted average of the intra prediction and the inter prediction of the region.

In some embodiments, the prediction mode is indicated in the bitstream.

In some embodiments, the prediction mode further comprises at least one of: a no prediction mode, an intra prediction mode, or an inter prediction mode.

In some embodiments, the region comprises at least one of: a node of the current frame, or a level of the current frame.

In some embodiments, the region comprises a node of the current frame, and the prediction mode is determined based on at least one eligibility condition, wherein the at least one eligibility condition is based on at least one of: a layer depth of the node, a geometry location of the node, attribute information of the node, or neighbor information of the node.

In some embodiments, the region comprises a node of the current frame, and the prediction mode is determined based on a rate-distortion optimization.

In some embodiments, at least one of a rate or a distortion for the rate-distortion optimization is estimated.

In some embodiments, at least one of a rate or a distortion for the rate-distortion optimization is determined based on at least one reconstructed value.

In some embodiments, the region comprises a node of the current frame, and an indication associated with the node indicates the prediction mode to be applied on the node.

In some embodiments, the indication is included in the bitstream.

In some embodiments, the indication is coded with one of: a fixed-length coding, a unary coding, or a truncated unary coding, or the indication is coded in a predictive manner.

In some embodiments, the prediction mode comprises a combined mode of a first prediction mode and a second prediction mode, and wherein if a first prediction value of the region based on the first prediction mode is not zero, a prediction value of the region is determined as the first prediction value, or wherein if the first prediction value of the region based on the first prediction mode is zero, a second prediction value of the region based on the second prediction mode is determined as the prediction value of the region.

In some embodiments, the region comprises a plurality of nodes, and the determined prediction mode is applied to the plurality of nodes.

In some embodiments, the prediction mode is determined based on at least one eligibility condition, wherein the at least one eligibility condition is based on at least one of: a layer depth of the region, a geometry location of the region, attribute information of the region, or neighbor information of nodes in the region.

In some embodiments, at least one indicator indicates at least one permitted layer depth or region in the at least one eligibility condition.

In some embodiments, the at least one indicator is indicated to a decoder.

In some embodiments, the at least one indicator is coded with one of: a fixed-length coding, a unary coding, or a truncated unary coding.

In some embodiments, the at least one indicator is coded with a predictive manner.

In some embodiments, the prediction mode is determined based on a rate-distortion optimization.

In some embodiments, at least one of a rate or a distortion of the rate-distortion optimization is estimated.

In some embodiments, at least one of a rate or a distortion of the rate-distortion optimization is calculated based on at least one reconstructed value.

In some embodiments, an indicator indicates that the prediction mode is determined to be applied to nodes in the region.

In some embodiments, the indicator is indicated to a decoder.

In some embodiments, the indicator is coded with one of: a fixed-length coding, a unary coding, or a truncated unary coding.

In some embodiments, the indicator is coded with a predictive manner.

In some embodiments, at least one parameter to determine the prediction mode is indicated in the bitstream.

In some embodiments, the at least one parameter indicates an eligibility condition for a prediction mode.

In some embodiments, an eligibility condition for a prediction mode is determined based on the at least one parameter.

In some embodiments, the at least one parameter indicates the region that needs to check at least one eligibility condition.

In some embodiments, for a first prediction mode, a first set of layers need to check the at least one eligibility condition, and a second set of layers do not apply the first prediction mode.

In some embodiments, for a first prediction mode, a first set of layers need to check the at least one eligibility condition, and a second set of layers apply the first prediction mode.

In some embodiments, at least one of the first set of layers or the second set of layers are determined based on the at least one parameter.

In some embodiments, the at least one parameter is indicated to a decoder.

In some embodiments, the at least one parameter is coded with one of: a fixed-length coding, a unary coding, or a truncated unary coding.

In some embodiments, the at least one parameter is coded with a predictive manner.

In some embodiments, a prediction value of a current node of the region is determined based on reference information from a plurality of reference frames.

In some embodiments, for each node of the region, a plurality of reference nodes are from the plurality of reference frames.

In some embodiments, for each reference node, an inter prediction value is determined.

In some embodiments, for each reference node, an indicator indicates the reference node.

In some embodiments, for the current node, the prediction value is determined based on an intra prediction value of the current node and a plurality of inter prediction values of the current node.

In some embodiments, for the current node, the prediction value is selected from a plurality of predictor candidates.

In some embodiments, the plurality of predictor candidates comprises an intra prediction value.

In some embodiments, the plurality of predictor candidates comprises an inter prediction value of a reference node if the reference node exists.

In some embodiments, the plurality of predictor candidates comprises a weighted average of an intra prediction value and a plurality of inter prediction values of a plurality of reference nodes if the plurality of reference nodes exist.

In some embodiments, the plurality of predictor candidates comprises a weighted average of an intra prediction value and an inter prediction value.

In some embodiments, the plurality of predictor candidates comprises a weighted average of a plurality of inter prediction values if a plurality of reference nodes exist.

In some embodiments, the selection is determined based on a rate-distortion optimization.

In some embodiments, at least one of a rate or a distortion of the rate-distortion optimization is estimated.

In some embodiments, at least one of a rate or a distortion of the rate-distortion optimization is calculated based on at least one reconstructed value.

In some embodiments, an indicator indicates a selected predictor candidate of the plurality of predictor candidates.

In some embodiments, the indicator is indicated to a decoder.

In some embodiments, the indicator is coded with one of: a fixed-length coding, a unary coding, or a truncated unary coding.

In some embodiments, the indicator is coded in a predictive manner.

In some embodiments, a plurality of weights for determining a prediction value of a current node of the region is fixed, or indicated in the bitstream, or determined during the conversion.

In some embodiments, the plurality of weights are fixed at a decoder.

In some embodiments, the plurality of weights are various for each layer, or for each node.

In some embodiments, the plurality of weights are consistent for a plurality of nodes.

In some embodiments, the plurality of weights are derived at a decoder.

In some embodiments, the plurality of weights are derived for each layer.

In some embodiments, the plurality of weights are derived based on a predictor candidate selection result of at least one node in a previous layer.

In some embodiments, the plurality of weights are derived based on a depth level.

In some embodiments, the plurality of weights are derived for each node.

In some embodiments, the plurality of weights are derived based on a predictor candidate selection result of at least one previous coded node, the at least one previous coded node comprising at least one of: a coded neighbor node, or a parent node.

In some embodiments, the plurality of weights are indicated to a decoder.

In some embodiments, the plurality of weights are indicated to the decoder for each layer.

In some embodiments, the plurality of weights are coded with one of: a fixed-length coding, a unary coding, or a truncated unary coding.

In some embodiments, the plurality of weights are coded in a predictive manner.

In some embodiments, the plurality of weights are selected from a predefined weights candidates list.

In some embodiments, the plurality of weights are selected based on one of: a rate-distortion optimization, a rate optimization, or a distortion optimization.

In some embodiments, at least one indicator indicates a selection result from the predefined weights candidate list.

In some embodiments, the at least one indicator is indicated to a decoder.

In some embodiments, the at least one indicator is coded with one of: a fixed-length coding, a unary coding, or a truncated unary coding.

In some embodiments, the at least one indicator is coded in a predictive manner.

In some embodiments, the selection is performed for each layer, or for each node.

In some embodiments, whether a weighted average of an intra prediction and an inter prediction is used is indicated.

In some embodiments, a first indicator indicates whether the weighted average of the intra prediction and the inter prediction is enabled for a whole sequence.

In some embodiments, a second indicator indicates whether the weighted average of the intra prediction and the inter prediction is enabled for a point cloud (PC) sample.

In some embodiments, a third indicator indicates whether the weighted average of the intra prediction and the inter prediction is enabled for a layer or a region.

In some embodiments, at least one of a first indicator, a second indicator or a third indicator regarding a usage of the weighted average is indicated to a decoder.

In some embodiments, the at least one of the first indicator, the second indicator or the third indicator is coded with one of: a fixed-length coding, a unary coding, or a truncated unary coding.

In some embodiments, the at least one of the first indicator, the second indicator or the third indicator is coded in a predictive manner.

According to embodiments of the present disclosure, a non-transitory computer-readable recording medium is proposed. A bitstream of a point cloud sequence is stored in the non-transitory computer-readable recording medium. The bitstream of the point cloud sequence is generated by a method performed by a point cloud sequence processing apparatus. According to the method, a prediction mode for a region of a current frame of the point cloud sequence is determined. The prediction mode at least comprises a first mode based on an intra prediction and an inter prediction. A prediction of the region is determined based on the prediction mode. The bitstream is generated based on the prediction.

According to embodiments of the present disclosure, a method for storing a bitstream of a point cloud sequence is proposed. In the method, a prediction mode for a region of a current frame of the point cloud sequence is determined. The prediction mode at least comprises a first mode based on an intra prediction and an inter prediction. A prediction of the region is determined based on the prediction mode. The bitstream is generated based on the prediction. The bitstream is stored in a non-transitory computer-readable recording medium.

FIG. 7 illustrates a flowchart of method 700 for point cloud coding in accordance with some embodiments of the present disclosure. The method 700 may be implemented during a conversion between a current frame of a point cloud sequence and a bitstream of the point cloud sequence. As shown in FIG. 7, the method 700 starts at block 710, where for a conversion between a current frame of a point cloud sequence and a bitstream of the point cloud sequence, it is determined that a region-adaptive hierarchical transform (RAHT) attribute coding is enabled for the current frame.

At block 720, the conversion is performed based on the RAHT attribute coding. If the RAHT attribute coding is enabled for the point cloud sequence, at least one parameter for at least one quantization matrix for RAHT coefficients is indicated in the bitstream. If the RAHT attribute coding is disabled for the point cloud sequence, the at least one parameter for the at least one quantization matrix for RAHT coefficients is excluded from the bitstream. In some embodiments the conversion may include encoding the current frame into the bitstream. Alternatively, or in addition, the conversion may include decoding the current frame from the bitstream.

The method 700 enables signaling parameter(s) for RAHT coefficients quantization matrices in the bitstream. The point cloud coding can thus be improved.

In some embodiments, the RAHT coefficients comprise at least one of: AC coefficients, or DC coefficients.

In some embodiments, the at least one quantization matrix comprises at least one of: at least one quantization matrix for AC coefficients, or at least one quantization matrix for DC coefficients.

In some embodiments, at least one indicator indicates whether the at least one quantization matrix for RAHT coefficients is indicated in the bitstream.

In some embodiments, if the RAHT attribute coding is enabled, the at least one indicator is indicated to a decoder.

In some embodiments, the at least one indicator is coded with one of: a fixed-length coding, a unary coding, or a truncated unary coding.

In some embodiments, the at least one indicator is coded in a predictive manner.

According to embodiments of the present disclosure, a non-transitory computer-readable recording medium is proposed. A bitstream of a point cloud sequence is stored in the non-transitory computer-readable recording medium. The bitstream of the point cloud sequence is generated by a method performed by a point cloud sequence processing apparatus. According to the method, it is determined that a region-adaptive hierarchical transform (RAHT) attribute coding is enabled for a current frame of the point cloud sequence. The bitstream is generated based on the RAHT attribute coding. At least one parameter for at least one quantization matrix for RAHT coefficients is indicated in the bitstream. If the RAHT attribute coding is enabled for the point cloud sequence, at least one parameter for at least one quantization matrix for RAHT coefficients is indicated in the bitstream. If the RAHT attribute coding is disabled for the point cloud sequence, the at least one parameter for the at least one quantization matrix for RAHT coefficients is excluded from the bitstream.

According to embodiments of the present disclosure, a method for storing a bitstream of a point cloud sequence is proposed. In the method, it is determined that a region-adaptive hierarchical transform (RAHT) attribute coding is enabled for a current frame of the point cloud sequence. The bitstream is generated based on the RAHT attribute coding. If the RAHT attribute coding is enabled for the point cloud sequence, at least one parameter for at least one quantization matrix for RAHT coefficients is indicated in the bitstream. If the RAHT attribute coding is disabled for the point cloud sequence, the at least one parameter for the at least one quantization matrix for RAHT coefficients is excluded from the bitstream. The bitstream is stored in a non-transitory computer-readable recording medium.

It is to be understood that the above method 600 and/or method 700 may be used in combination or separately. Any suitable combination of these methods may be applied. Scope of the present disclosure is not limited in this regard.

In some embodiments, an indicator indicating whether to apply the method 600 and/or method 700 may be included in the bitstream. By way of example, the indicator may be included from an encoder to a decoder in one of the following: the bitstream, a frame, a tile, a slice, or an octree.

Alternatively, or in addition, in some embodiments, whether to and/or how to apply the method 600 and/or method 700 may be determined based on coded information. By way of example, the coded information may include at least one of: a dimension, a colour format, a colour component, a slice type, or a picture type.

By using the method 600 and/or method 700 separately or in combination, the coding effectiveness and coding efficiency of the point cloud coding can be improved.

Implementations of the present disclosure can be described in view of the following clauses, the features of which can be combined in any reasonable manner.

Clause 1. A method for point cloud coding, comprising: determining, for a conversion between a current frame of a point cloud sequence and a bitstream of the point cloud sequence, a prediction mode for a region of the current frame, the prediction mode at least comprising a first mode based on an intra prediction and an inter prediction; determining a prediction of the region based on the prediction mode; and performing the conversion based on the prediction.

Clause 2. The method of clause 1, wherein in the first mode, the prediction of the region comprises a weighted average of the intra prediction and the inter prediction of the region.

Clause 3. The method of clause 1 or 2, wherein the prediction mode is indicated in the bitstream.

Clause 4. The method of any of clauses 1-3, wherein the prediction mode further comprises at least one of: a no prediction mode, an intra prediction mode, or an inter prediction mode.

Clause 5. The method of any of clauses 1-4, wherein the region comprises at least one of: a node of the current frame, or a level of the current frame.

Clause 6. The method of any of clauses 1-5, wherein the region comprises a node of the current frame, and the prediction mode is determined based on at least one eligibility condition, wherein the at least one eligibility condition is based on at least one of: a layer depth of the node, a geometry location of the node, attribute information of the node, or neighbor information of the node.

Clause 7. The method of any of clauses 1-6, wherein the region comprises a node of the current frame, and the prediction mode is determined based on a rate-distortion optimization.

Clause 8. The method of clause 7, wherein at least one of a rate or a distortion for the rate-distortion optimization is estimated.

Clause 9. The method of clause 7, wherein at least one of a rate or a distortion for the rate-distortion optimization is determined based on at least one reconstructed value.

Clause 10. The method of any of clauses 1-9, wherein the region comprises a node of the current frame, and an indication associated with the node indicates the prediction mode to be applied on the node.

Clause 11. The method of clause 10, wherein the indication is included in the bitstream.

Clause 12. The method of clause 10 or 11, wherein the indication is coded with one of: a fixed-length coding, a unary coding, or a truncated unary coding, or the indication is coded in a predictive manner.

Clause 13. The method of any of clauses 1-12, wherein the prediction mode comprises a combined mode of a first prediction mode and a second prediction mode, and wherein if a first prediction value of the region based on the first prediction mode is not zero, a prediction value of the region is determined as the first prediction value, or wherein if the first prediction value of the region based on the first prediction mode is zero, a second prediction value of the region based on the second prediction mode is determined as the prediction value of the region.

Clause 14. The method of any of clauses 1-13, wherein the region comprises a plurality of nodes, and the determined prediction mode is applied to the plurality of nodes.

Clause 15. The method of any of clauses 1-14, wherein the prediction mode is determined based on at least one eligibility condition, wherein the at least one eligibility condition is based on at least one of: a layer depth of the region, a geometry location of the region, attribute information of the region, or neighbor information of nodes in the region.

Clause 16. The method of clause 15, wherein at least one indicator indicates at least one permitted layer depth or region in the at least one eligibility condition.

Clause 17. The method of clause 16, wherein the at least one indicator is indicated to a decoder.

Clause 18. The method of clause 16 or 17, wherein the at least one indicator is coded with one of: a fixed-length coding, a unary coding, or a truncated unary coding.

Clause 19. The method of clause 16 or 17, wherein the at least one indicator is coded with a predictive manner.

Clause 20. The method of any of clauses 1-19, wherein the prediction mode is determined based on a rate-distortion optimization.

Clause 21. The method of clause 20, wherein at least one of a rate or a distortion of the rate-distortion optimization is estimated.

Clause 22. The method of clause 20, wherein at least one of a rate or a distortion of the rate-distortion optimization is calculated based on at least one reconstructed value.

Clause 23. The method of any of clauses 1-22, wherein an indicator indicates that the prediction mode is determined to be applied to nodes in the region.

Clause 24. The method of clause 23, wherein the indicator is indicated to a decoder.

Clause 25. The method of clause 23 or 24, wherein the indicator is coded with one of: a fixed-length coding, a unary coding, or a truncated unary coding.

Clause 26. The method of clause 23 or 24, wherein the indicator is coded with a predictive manner.

Clause 27. The method of any of clauses 1-26, wherein at least one parameter to determine the prediction mode is indicated in the bitstream.

Clause 28. The method of clause 27, wherein the at least one parameter indicates an eligibility condition for a prediction mode.

Clause 29. The method of clause 27, wherein an eligibility condition for a prediction mode is determined based on the at least one parameter.

Clause 30. The method of clause 27, wherein the at least one parameter indicates the region that needs to check at least one eligibility condition.

Clause 31. The method of clause 30, wherein for a first prediction mode, a first set of layers need to check the at least one eligibility condition, and a second set of layers do not apply the first prediction mode.

Clause 32. The method of clause 30, wherein for a first prediction mode, a first set of layers need to check the at least one eligibility condition, and a second set of layers apply the first prediction mode.

Clause 33. The method of clause 31 or 32, wherein at least one of the first set of layers or the second set of layers are determined based on the at least one parameter.

Clause 34. The method of any of clauses 27-33, wherein the at least one parameter is indicated to a decoder.

Clause 35. The method of clause 34, wherein the at least one parameter is coded with one of: a fixed-length coding, a unary coding, or a truncated unary coding.

Clause 36. The method of clause 34, wherein the at least one parameter is coded with a predictive manner.

Clause 37. The method of any of clauses 1-36, wherein a prediction value of a current node of the region is determined based on reference information from a plurality of reference frames.

Clause 38. The method of clause 37, wherein for each node of the region, a plurality of reference nodes are from the plurality of reference frames.

Clause 39. The method of claim 38, wherein for each reference node, an inter prediction value is determined.

Clause 40. The method of clause 38 or 39, wherein for each reference node, an indicator indicates the reference node.

Clause 41. The method of any of clauses 37-40, wherein for the current node, the prediction value is determined based on an intra prediction value of the current node and a plurality of inter prediction values of the current node.

Clause 42. The method of any of clauses 37-40, wherein for the current node, the prediction value is selected from a plurality of predictor candidates.

Clause 43. The method of clause 42, wherein the plurality of predictor candidates comprises an intra prediction value.

Clause 44. The method of clause 43, wherein the plurality of predictor candidates comprises an inter prediction value of a reference node if the reference node exists.

Clause 45. The method of clause 42, wherein the plurality of predictor candidates comprises a weighted average of an intra prediction value and a plurality of inter prediction values of a plurality of reference nodes if the plurality of reference nodes exist.

Clause 46. The method of clause 42, wherein the plurality of predictor candidates comprises a weighted average of an intra prediction value and an inter prediction value.

Clause 47. The method of clause 42, wherein the plurality of predictor candidates comprises a weighted average of a plurality of inter prediction values if a plurality of reference nodes exist.

Clause 48. The method of any of clauses 42-47, wherein the selection is determined based on a rate-distortion optimization.

Clause 49. The method of clause 48, wherein at least one of a rate or a distortion of the rate-distortion optimization is estimated.

Clause 50. The method of clause 48, wherein at least one of a rate or a distortion of the rate-distortion optimization is calculated based on at least one reconstructed value.

Clause 51. The method of any of clauses 42-50, wherein an indicator indicates a selected predictor candidate of the plurality of predictor candidates.

Clause 52. The method of clause 51, wherein the indicator is indicated to a decoder.

Clause 53. The method of clause 51 or 52, wherein the indicator is coded with one of: a fixed-length coding, a unary coding, or a truncated unary coding.

Clause 54. The method of clause 51 or 52, wherein the indicator is coded in a predictive manner.

Clause 55. The method of any of clauses 1-54, wherein a plurality of weights for determining a prediction value of a current node of the region is fixed, or indicated in the bitstream, or determined during the conversion.

Clause 56. The method of clause 55, wherein the plurality of weights are fixed at a decoder.

Clause 57. The method of clause 56, wherein the plurality of weights are various for each layer, or for each node.

Clause 58. The method of clause 56, wherein the plurality of weights are consistent for a plurality of nodes.

Clause 59. The method of clause 55, wherein the plurality of weights are derived at a decoder.

Clause 60. The method of clause 59, wherein the plurality of weights are derived for each layer.

Clause 61. The method of clause 60, wherein the plurality of weights are derived based on a predictor candidate selection result of at least one node in a previous layer.

Clause 62. The method of clause 60, wherein the plurality of weights are derived based on a depth level.

Clause 63. The method of clause 59, wherein the plurality of weights are derived for each node.

Clause 64. The method of clause 63, wherein the plurality of weights are derived based on a predictor candidate selection result of at least one previous coded node, the at least one previous coded node comprising at least one of: a coded neighbor node, or a parent node.

Clause 65. The method of clause 55, wherein the plurality of weights are indicated to a decoder.

Clause 66. The method of clause 65, wherein the plurality of weights are indicated to the decoder for each layer.

Clause 67. The method of clause 65 or 66, wherein the plurality of weights are coded with one of: a fixed-length coding, a unary coding, or a truncated unary coding.

Clause 68. The method of clause 65 or 66, wherein the plurality of weights are coded in a predictive manner.

Clause 69. The method of clause 55, wherein the plurality of weights are selected from a predefined weights candidates list.

Clause 70. The method of clause 69, wherein the plurality of weights are selected based on one of: a rate-distortion optimization, a rate optimization, or a distortion optimization.

Clause 71. The method of clause 69, wherein at least one indicator indicates a selection result from the predefined weights candidate list.

Clause 72. The method of clause 71, wherein the at least one indicator is indicated to a decoder.

Clause 73. The method of clause 72, wherein the at least one indicator is coded with one of: a fixed-length coding, a unary coding, or a truncated unary coding.

Clause 74. The method of clause 72, wherein the at least one indicator is coded in a predictive manner.

Clause 75. The method of clause 69, wherein the selection is performed for each layer, or for each node.

Clause 76. The method of any of clauses 1-75, wherein whether a weighted average of an intra prediction and an inter prediction is used is indicated.

Clause 77. The method of clause 76, wherein a first indicator indicates whether the weighted average of the intra prediction and the inter prediction is enabled for a whole sequence.

Clause 78. The method of clause 76, wherein a second indicator indicates whether the weighted average of the intra prediction and the inter prediction is enabled for a point cloud (PC) sample.

Clause 79. The method of clause 76, wherein a third indicator indicates whether the weighted average of the intra prediction and the inter prediction is enabled for a layer or a region.

Clause 80. The method of any of clauses 77-79, wherein at least one of a first indicator, a second indicator or a third indicator regarding a usage of the weighted average is indicated to a decoder.

Clause 81. The method of clause 80, wherein the at least one of the first indicator, the second indicator or the third indicator is coded with one of: a fixed-length coding, a unary coding, or a truncated unary coding.

Clause 82. The method of clause 80, wherein the at least one of the first indicator, the second indicator or the third indicator is coded in a predictive manner.

Clause 83. A method for point cloud coding, comprising: determining, for a conversion between a current frame of a point cloud sequence and a bitstream of the point cloud sequence, that a region-adaptive hierarchical transform (RAHT) attribute coding is enabled for the current frame; and performing the conversion based on the RAHT attribute coding, wherein if the RAHT attribute coding is enabled for the point cloud sequence, at least one parameter for at least one quantization matrix for RAHT coefficients is indicated in the bitstream, and wherein if the RAHT attribute coding is disabled for the point cloud sequence, the at least one parameter for the at least one quantization matrix for RAHT coefficients is excluded from the bitstream.

Clause 84. The method of clause 83, wherein the RAHT coefficients comprise at least one of: AC coefficients, or DC coefficients.

Clause 85. The method of clause 83 or 84, wherein the at least one quantization matrix comprises at least one of: at least one quantization matrix for AC coefficients, or at least one quantization matrix for DC coefficients.

Clause 86. The method of any of clauses 83-85, wherein at least one indicator indicates whether the at least one quantization matrix for RAHT coefficients is indicated in the bitstream.

Clause 87. The method of clause 86, wherein if the RAHT attribute coding is enabled, the at least one indicator is indicated to a decoder.

Clause 88. The method of clause 86 or 87, wherein the at least one indicator is coded with one of: a fixed-length coding, a unary coding, or a truncated unary coding.

Clause 89. The method of clause 86 or 87, wherein the at least one indicator is coded in a predictive manner.

Clause 90. The method of any of clauses 1-89, wherein an indicator indicates whether to and/or how to apply the method is indicated in one of: the bitstream, a frame, a tile, a slice, or an octree.

Clause 91. The method of any of clauses 1-89, further comprising: determining whether to and/or how to apply the method based on coded information, the coded information comprising at least one of: a dimension, a colour format, a colour component, a slice type, or a picture type.

Clause 92. The method of any of clauses 1-91, wherein the conversion includes encoding the current frame into the bitstream.

Clause 93. The method of any of clauses 1-91, wherein the conversion includes decoding the current frame from the bitstream.

Clause 94. An apparatus for processing point cloud data comprising a processor and a non-transitory memory with instructions thereon, wherein the instructions upon execution by the processor, cause the processor to perform a method in accordance with any of clauses 1-93.

Clause 95. A non-transitory computer-readable storage medium storing instructions that cause a processor to perform a method in accordance with any of clauses 1-93.

Clause 96. A non-transitory computer-readable recording medium storing a bitstream of a point cloud sequence which is generated by a method performed by a point cloud processing apparatus, wherein the method comprises: determining a prediction mode for a region of a current frame of the point cloud sequence, the prediction mode at least comprising a first mode based on an intra prediction and an inter prediction; determining a prediction of the region based on the prediction mode; and generating the bitstream based on the prediction.

Clause 97. A method for storing a bitstream of a point cloud sequence, comprising: determining a prediction mode for a region of a current frame of the point cloud sequence, the prediction mode at least comprising a first mode based on an intra prediction and an inter prediction; determining a prediction of the region based on the prediction mode; generating the bitstream based on the prediction; and storing the bitstream in a non-transitory computer-readable recording medium.

Clause 98. A non-transitory computer-readable recording medium storing a bitstream of a point cloud sequence which is generated by a method performed by a point cloud processing apparatus, wherein the method comprises: determining that a region-adaptive hierarchical transform (RAHT) attribute coding is enabled for a current frame of the point cloud sequence; and generating the bitstream based on the RAHT attribute coding, wherein if the RAHT attribute coding is enabled for the point cloud sequence, at least one parameter for at least one quantization matrix for RAHT coefficients is indicated in the bitstream, and wherein if the RAHT attribute coding is disabled for the point cloud sequence, the at least one parameter for the at least one quantization matrix for RAHT coefficients is excluded from the bitstream.

Clause 99. A method for storing a bitstream of a point cloud sequence, comprising: determining that a region-adaptive hierarchical transform (RAHT) attribute coding is enabled for a current frame of the point cloud sequence; generating the bitstream based on the RAHT attribute coding; and storing the bitstream in a non-transitory computer-readable recording medium, wherein if the RAHT attribute coding is enabled for the point cloud sequence, at least one parameter for at least one quantization matrix for RAHT coefficients is indicated in the bitstream, and wherein if the RAHT attribute coding is disabled for the point cloud sequence, the at least one parameter for the at least one quantization matrix for RAHT coefficients is excluded from the bitstream.

### Example Device

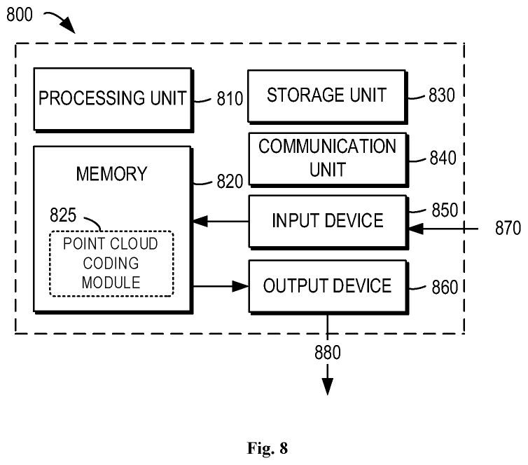

FIG. 8 illustrates a block diagram of a computing device 800 in which various embodiments of the present disclosure can be implemented. The computing device 800 may be implemented as or included in the source device 110 (or the GPCC encoder 116 or 200) or the destination device 120 (or the GPCC decoder 126 or 300).

It would be appreciated that the computing device 800 shown in FIG. 8 is merely for purpose of illustration, without suggesting any limitation to the functions and scopes of the embodiments of the present disclosure in any manner.

As shown in FIG. 8, the computing device 800 includes a general-purpose computing device 800. The computing device 800 may at least comprise one or more processors or processing units 810, a memory 820, a storage unit 830, one or more communication units 840, one or more input devices 850, and one or more output devices 860.

In some embodiments, the computing device 800 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 800 can support any type of interface to a user (such as “wearable” circuitry and the like).

The processing unit 810 may be a physical or virtual processor and can implement various processes based on programs stored in the memory 820. In a multi-processor system, multiple processing units execute computer executable instructions in parallel so as to improve the parallel processing capability of the computing device 800. The processing unit 810 may also be referred to as a central processing unit (CPU), a microprocessor, a controller or a microcontroller.

The computing device 800 typically includes various computer storage medium. Such medium can be any medium accessible by the computing device 800, including, but not limited to, volatile and non-volatile medium, or detachable and non-detachable medium. The memory 820 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 830 may be any detachable or non-detachable medium and may include a machine-readable medium such as a memory, flash memory drive, magnetic disk or another other media, which can be used for storing information and/or data and can be accessed in the computing device 800.

The computing device 800 may further include additional detachable/non-detachable, volatile/non-volatile memory medium. Although not shown in FIG. 8, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 840 communicates with a further computing device via the communication medium. In addition, the functions of the components in the computing device 800 can be implemented by a single computing cluster or multiple computing machines that can communicate via communication connections. Therefore, the computing device 800 can operate in a networked environment using a logical connection with one or more other servers, networked personal computers (PCs) or further general network nodes.

The input device 850 may be one or more of a variety of input devices, such as a mouse, keyboard, tracking ball, voice-input device, and the like. The output device 860 may be one or more of a variety of output devices, such as a display, loudspeaker, printer, and the like. By means of the communication unit 840, the computing device 800 can further communicate with one or more external devices (not shown) such as the storage devices and display device, with one or more devices enabling the user to interact with the computing device 800, or any devices (such as a network card, a modem and the like) enabling the computing device 800 to communicate with one or more other computing devices, if required. Such communication can be performed via input/output (I/O) interfaces (not shown).

In some embodiments, instead of being integrated in a single device, some or all components of the computing device 800 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 800 may be used to implement point cloud encoding/decoding in embodiments of the present disclosure. The memory 820 may include one or more point cloud coding modules 825 having one or more program instructions. These modules are accessible and executable by the processing unit 810 to perform the functionalities of the various embodiments described herein.

In the example embodiments of performing point cloud encoding, the input device 850 may receive point cloud data as an input 870 to be encoded. The point cloud data may be processed, for example, by the point cloud coding module 825, to generate an encoded bitstream. The encoded bitstream may be provided via the output device 860 as an output 880.

In the example embodiments of performing point cloud decoding, the input device 850 may receive an encoded bitstream as the input 870. The encoded bitstream may be processed, for example, by the point cloud coding module 825, to generate decoded point cloud data. The decoded point cloud data may be provided via the output device 860 as the output 880.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for point cloud coding, comprising:
determining, for a conversion between a current frame of a point cloud sequence and a bitstream of the point cloud sequence, a prediction mode for a region of the current frame, the region comprising a node of the current frame; and
performing the conversion based on the prediction mode.

2. The method of claim 1, wherein the prediction mode comprises at least one of:
a no prediction mode,
an intra prediction mode, or
an inter prediction mode.

3. The method of claim 1, wherein the prediction mode is determined based on at least one eligibility condition, wherein the at least one eligibility condition is based on at least one of:
a layer depth of the node,
a geometry location of the node,
attribute information of the node, or
neighbor information of the node.

4. The method of claim 1, wherein an indication associated with the node indicates the prediction mode to be applied on the node.

5. The method of claim 4, wherein the indication is included in the bitstream.

6. The method of claim 5, wherein the indication is coded with one of: a fixed-length coding, a unary coding, or a truncated unary coding, or the indication is coded in a predictive manner.

7. The method of claim 1, wherein a plurality of weights for determining a prediction value of a current node of the region is fixed, or indicated in the bitstream, or determined during the conversion.

8. The method of claim 7, wherein the plurality of weights are derived at a decoder.

9. The method of claim 8, wherein the plurality of weights are derived for each layer or for each node.

10. The method of claim 9, wherein the plurality of weights are derived based on at least one of:
a predictor candidate selection result of at least one node in a previous layer, or
a depth level.

11. The method of claim 8, wherein the plurality of weights are derived for each node.

12. The method of claim 11, wherein the plurality of weights are derived based on a predictor candidate selection result of at least one previous coded node, the at least one previous coded node comprising at least one of: a coded neighbor node, or a parent node.

13. The method of claim 1, wherein the prediction mode at least comprises a first mode based on an intra prediction and an inter prediction, and whether a weighted average of the intra prediction and the inter prediction is used is indicated.

14. The method of claim 13, wherein a first indicator indicates whether the weighted average of the intra prediction and the inter prediction is enabled for a whole sequence.

15. The method of claim 1, wherein in accordance with a flag indicating whether lossless coding is applied being equal to 1, the prediction mode is determined based on a weight associated with a child layer depth of the node, or
in accordance with the flag indicating whether lossless coding is applied being equal to 0 or being absent, the prediction mode is determined based on a weight associated with a geometry of the node.

16. The method of claim 1, wherein the conversion includes encoding the current frame into the bitstream.

17. The method of claim 1, wherein the conversion includes decoding the current frame from the bitstream.

18. The method of claim 1, wherein the conversion comprises: generating the bitstream from the point cloud sequence, and
the method further comprises: storing the bitstream in a non-transitory computer-readable recording medium.

19. An apparatus for processing point cloud data comprising a processor and a non-transitory memory with instructions thereon, wherein the instructions upon execution by the processor, cause the processor to perform:
determining, for a conversion between a current frame of a point cloud sequence and a bitstream of the point cloud sequence, a prediction mode for a region of the current frame, the region comprising a node of the current frame; and
performing the conversion based on the prediction mode.

20. A non-transitory computer-readable storage medium storing instructions that cause a processor to perform:
determining, for a conversion between a current frame of a point cloud sequence and a bitstream of the point cloud sequence, a prediction mode for a region of the current frame, the region comprising a node of the current frame; and
performing the conversion based on the prediction mode.
